(19) United States
(12) Patent Application Publication
(10) Pub. No.: US 2025/0391167 A1
(43) Pub. Date: Dec. 25, 2025

(54) DISPLAY CONTROL SYSTEM AND DISPLAY CONTROL METHOD

(71) Applicant: Panasonic Automotive Systems Co., Ltd., Kanagawa (JP)

(72) Inventor: Satoshi FUKUMOTO, Tokyo (JP)

(73) Assignee: Panasonic Automotive Systems Co., Ltd., Kanagawa (JP)

(21) Appl. No.: 19/229,480

(22) Filed: Jun. 5, 2025

(30) Foreign Application Priority Data
Jun. 24, 2024 (JP) 2024-101448

(51) Int. Cl. G06V 20/20; B60K 35/23; G06V 10/44; G06V 10/77; G06V 20/58

(52) U.S. Cl. CPC G06V 20/20; G06V 20/58; B60K 35/23; B60K 2360/166; B60K 2360/191; G06V 10/44; G06V 10/7715

(57) ABSTRACT

A display control system includes a first obtainer, a second obtainer, an extractor, a generator, and a display controller. The first obtainer obtains a surrounding image including at least an area forward of a vehicle and an area that is lateral to the vehicle and is on a side where an obstacle to the vehicle is present. The second obtainer obtains a steering angle of the vehicle. The extractor extracts an edge of the obstacle in the surrounding image. The generator generates an emphasized image that emphasizes the edge extracted, and a course image that represents a travel course of the vehicle predicted based on the steering angle. The display controller displays the emphasized image generated and the course image generated, in a superimposed manner, on a display device provided to the vehicle.

### CROSS REFERENCE TO RELATED APPLICATION

The present application is based on and claims priority of Japanese Patent Application No. 2024-101448 filed on Jun. 24, 2024.

### FIELD

The present disclosure relates to a display control system and a display control method for controlling a display device provided to a vehicle.

### BACKGROUND

Patent Literature (PTL) 1 discloses a device for monitoring the surroundings for a vehicle. The device for monitoring the surroundings for a vehicle captures an image of a lateral area of a vehicle including a side surface of the vehicle, detects edges in a direction parallel to a road based on the captured image, and extracts an edge of a three-dimensional obstacle from among the edges detected. The device for monitoring the surroundings for a vehicle also informs an occupant of a degree of proximity of the vehicle to the three-dimensional obstacle based on a positional relationship between the extracted edge of the three-dimensional obstacle and the vehicle.

### CITATION LIST

### Patent Literature

PTL 1: Japanese Patent No. 4033017

### SUMMARY

The present disclosure provides a display control system, etc., capable of improving upon the above related art.

A display control system according to an aspect of the present disclosure includes a first obtainer, a second obtainer, an extractor, a generator, and a display controller. The first obtainer obtains a surrounding image including at least an area forward of a vehicle and an area that is lateral to the vehicle and is on a side where an obstacle to the vehicle is present. The second obtainer obtains a steering angle of the vehicle. The extractor extracts an edge of the obstacle in the surrounding image. The generator generates an emphasized image that emphasizes the edge extracted, and a course image that represents a travel course of the vehicle predicted based on the steering angle. The display controller displays the emphasized image generated and the course image generated, in a superimposed manner, on a display device provided to the vehicle.

In a display control method according to an aspect of the present disclosure, a surrounding image including at least an area forward of a vehicle and an area that is lateral to the vehicle and is on a side where an obstacle to the vehicle is present is obtained. In the display control method, a steering angle of the vehicle is obtained. In the display control method, an edge of the obstacle in the surrounding image is extracted. In the display control method, an emphasized image that emphasizes the edge extracted, and a course image that represents a travel course of the vehicle predicted based on the steering angle are generated. In the display control method, the emphasized image generated and the course image generated are displayed, in a superimposed manner, on a display device provided to the vehicle.

The display control system, etc., of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating an overview of a display control system according to an embodiment.

FIG. 2 is a diagram illustrating an example of an image displayed on a display device by the display control system according to the embodiment.

FIG. 3 is a diagram illustrating another example of the image displayed on the display device by the display control system according to the embodiment.

FIG. 4 is a flowchart showing an example of operations of the display control system according to the embodiment.

### DESCRIPTION OF EMBODIMENT

An embodiment will be specifically described below with reference to the drawings.

The embodiment described below shows a general or specific example. The numerical values, shapes, materials, elements, the arrangement and connection of the elements, steps, the processing order of the steps, etc. shown in the following embodiment are mere examples, and therefore do not limit the scope of the present disclosure. Among the elements in the following embodiment, those not recited in the independent claims are described as optional elements.

Each of the figures is a schematic diagram and is not necessarily drawn in a precise manner. In the figures, the same elements are denoted by the same reference numerals.

### EMBODIMENT

### (Overview)

The point to which the present inventor has directed his attention will be described first.

A technique for extracting an edge of a three-dimensional obstacle (in this case, a curb on the shoulder of a road) based on an image obtained by image-capturing a lateral area of a vehicle including a side surface of the vehicle, and informing an occupant of the vehicle coming close to the extracted edge of the curb by means of a warning sound or voice announcement has been conventionally known as disclosed in PTL 1, for example. This technique produces an effect of relieving, when the driver of the vehicle attempts to pull over to the shoulder of the road, the driver's anxiety about the vehicle coming into contact with the curb.

However, the above-described technique cannot completely eliminate the anxiety of a driver who is not good at pulling over to the shoulder of a road. Specifically, with the above-described technique, during an attempt to pull over to the shoulder of the road, the driver drives while worrying about when the warning sound or voice announcement will be made. After all, the driver drives with anxiety.

In view of the above, the present inventor has invented a display control system, etc. that can easily reduce the anxiety a driver of a vehicle may have when driving, especially in driving when the driver attempts to pull over to the shoulder of a road. The present disclosure provides such a display control system, etc. that can easily reduce the anxiety a driver of a vehicle may have when driving.

### (Configuration)

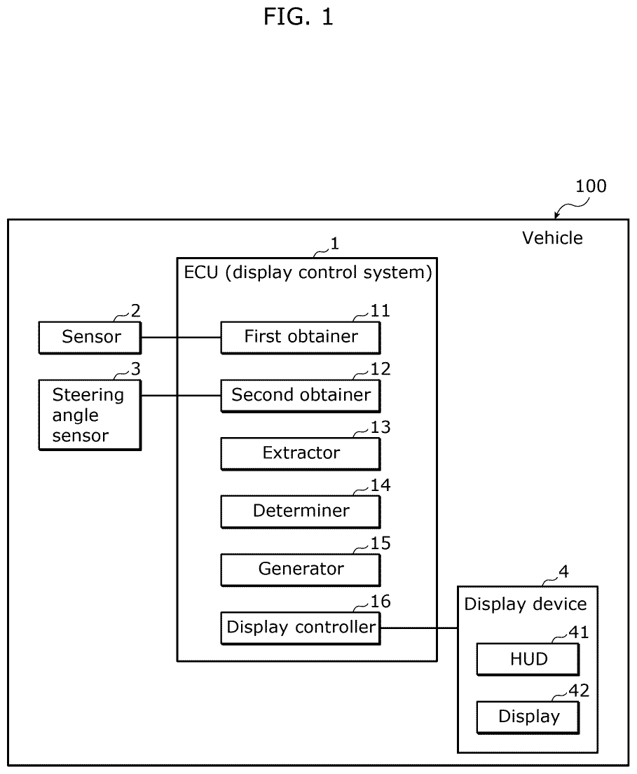

A configuration of display control system 1 according to the embodiment will be described below. FIG. 1 is a block diagram illustrating an overview of display control system 1 according to the embodiment. Display control system 1 is a system used for a mobile object such as vehicle 100, for example, to support the driving of vehicle 100 by controlling display device 4 provided to vehicle 100. In the embodiment, display control system 1 is implemented by an in-vehicle device, but may also be implemented by an external device brought in from outside vehicle 100.

Vehicle 100 will be described in the embodiment as what is called a right-hand drive type in which a steering wheel is provided on a front right seat. Note that vehicle 100 may be of what is called a left-hand drive type in which a steering wheel is provided on a front left seat.

The directions such as “forward”, “rearward”, “leftward”, “rightward”, and “upward” in the following description are directions as viewed from the driver of vehicle 100. For example, the “forward” direction is the direction in which the driver of vehicle 100 is looking toward windshield 101 (see FIG. 3). Other directions, such as the “leftward” direction, are directions based on the driver of vehicle 100 looking toward windshield 101.

Display control system 1 is implemented, for example, by an Electronic Control Unit (ECU). More specifically, display control system 1 is implemented, for example, by a processor included in the ECU executing a program stored in a memory included in the ECU. As shown in FIG. 1, display control system 1 includes first obtainer 11, second obtainer 12, extractor 13, determiner 14, generator 15, and display controller 16.

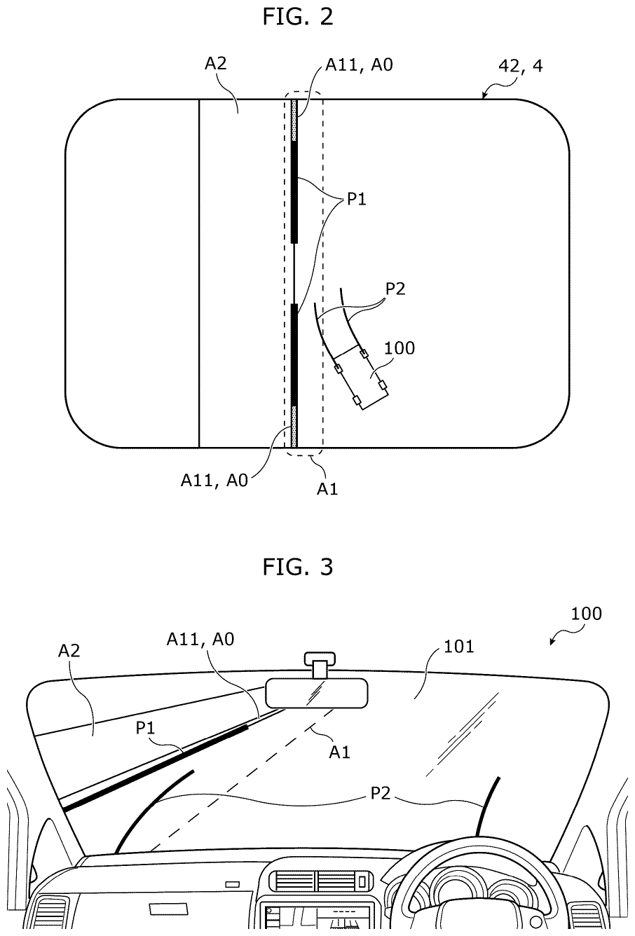

First obtainer 11 obtains a surrounding image. The surrounding image as used herein refers to an image including at least an area forward of vehicle 100 and an area that is lateral to vehicle 100 and is on the side where obstacle A0 (see FIG. 2) to vehicle 100 is present. Obstacle A0 is an object that obstructs the travel of vehicle 100, i.e., an object with which it is undesirable for vehicle 100 to come into contact. An example of obstacle A0 may be curb A11 (see FIG. 2), a gutter, a wall, or a utility pole on shoulder A1 (see FIG. 2) of the road. The embodiment will be described assuming that obstacle A0 is curb A11 on shoulder A1 of the road. The surrounding image is an image including at least the area forward of vehicle 100 and the area leftward of vehicle 100.

In the embodiment, first obtainer 11 obtains the surrounding image by obtaining a detection result of sensor 2 and generating the surrounding image based on the obtained detection result. When sensor 2 generates a surrounding image, first obtainer 11 obtains the surrounding image from sensor 2 without generating the surrounding image.

Sensor 2 is included in vehicle 100 to detect the surrounding conditions of vehicle 100. Specifically, sensor 2 detects, for example, objects such as pedestrians, other vehicles, and obstacles A0 that are present around vehicle 100, as well as the positions of such objects. Any of various sensors such as a camera (image sensor), a sonar sensor, a radar, or a Light Detection and Ranging (LIDAR) sensor, for example, may be used as sensor 2.

Second obtainer 12 obtains a steering angle of vehicle 100. In the embodiment, second obtainer 12 obtains the steering angle of vehicle 100 by obtaining a detection result of steering angle sensor 3.

Steering angle sensor 3 is provided in the steering wheel of vehicle 100, for example, to detect the angle of the steering wheel, i.e., the steering angle of vehicle 100.

Extractor 13 extracts an edge of obstacle A0 in the surrounding image obtained by first obtainer 11. In the embodiment, extractor 13 extracts, as the edge of obstacle A0, the edge of curb A11 on shoulder A1 of the road in the surrounding image. The edge is extracted as a linear image along a direction parallel to the road on which vehicle 100 is traveling (e.g., front-back direction). For example, extractor 13 detects the edge of obstacle A0 by executing, on the surrounding image, an appropriate algorithm to extract image feature values. Alternatively, extractor 13 may extract the edge of obstacle A0 from the surrounding image by using a trained model having gone through machine learning in advance to output the edge of obstacle A0 using the surrounding image as an input.

Alternatively, extractor 13 may extract the edge of obstacle A0 from the surrounding image by using the technique disclosed in PTL 1, for example. Specifically, extractor 13 detects, from the surrounding image, one or more edges in the direction parallel to the road on which vehicle 100 is traveling (e.g., front-back direction). Extractor 13 may then extract the edge of obstacle A0 by excluding the edge of a white line on the road from the one or more edges based on luminance change in a direction in which the detected one or more edges are present side by side (e.g., left-right direction).

Determiner 14 determines whether emphasized image P1 and course image P2, which will be described below, are to be displayed, in a superimposed manner, on display device 4. In the embodiment, when the driving mode of vehicle 100 is shifted to a pull-over mode, determiner 14 determines that emphasized image P1 and course image P2 are to be displayed, in a superimposed manner, on display device 4.

The pull-over mode as used herein refers to a mode to perform a pull-over operation of pulling vehicle 100 over to obstacle A0 (in this case, curb A11 on shoulder A1 of the road). The shifting of the driving mode of vehicle 100 to the pull-over mode is performed, for example, by the driver operating a switch provided on the steering wheel of vehicle 100. For example, if display 42 of vehicle 100, which will be described below, is a touch-screen display, the shifting of the driving mode of vehicle 100 to the pull-over mode may be performed by the driver touching an icon of the pull-over mode displayed on the touch-screen display.

Note that determiner 14 may determine that neither emphasized image P1 nor course image P2 is to be displayed, in a superimposed manner, on display device 4 when the driving mode of vehicle 100 is in a mode other than the pull-over mode.

Generator 15 generates emphasized image P1 that emphasizes the edge extracted by extractor 13. Generator 15 also generates course images P2 that represent a travel course of vehicle 100 predicted based on the steering angle obtained by second obtainer 12.

For example, generator 15 generates, as emphasized image P1, a linear image corresponding to the road-side edge of curb A11 on shoulder A1 of the road, which has been extracted by extractor 13. For example, generator 15 generates, as emphasized image P1, a linear image that is thicker than a straight line indicating the edge of curb A11. For example, generator 15 also predicts, based on the steering angle of vehicle 100 at a point in time when obtained by second obtainer 12, trajectories that front wheels of vehicle 100 will follow when the steering angle is assumed to be maintained for a certain period of time, and generates, as course images P2, linear or curved images representing the predicted trajectories.

Display controller 16 displays emphasized image P1 and course images P2 generated by generator 15, in a superimposed manner, on display device 4 provided to vehicle 100. In the embodiment, display controller 16 displays the images, in a superimposed manner, on display device 4 according to the determination result of determiner 14. For example, when the driving mode of vehicle 100 is shifted to the pull-over mode, display controller 16 displays emphasized image P1 and course images P2, in a superimposed manner, on display device 4.

When the edge of obstacle A0 cannot be extracted by extractor 13, display controller 16 may display only course images P2, in a superimposed manner, on display device 4. Here, such a situation in which the edge of obstacle A0 cannot be extracted by extractor 13 may occur, for example, when no obstacle A0 is included in the surrounding image, or when obstacle A0 is included in the surrounding image, but part of obstacle A0 is missing or obstacle A0 is not clearly shown in the surrounding image, for example, thus failing to be recognized as obstacle A0.

Display device 4 is an image display device provided to vehicle 100. In the embodiment, display device 4 includes a Head-Up Display (hereinafter, also referred to as “HUD”) 41 and display 42.

HUD 41 is a device disposed on an instrument panel of vehicle 100, for projecting an image presenting various information onto windshield 101 of vehicle 100 to show the image in the visual field of the driver.

Display 42 is a display located inside vehicle 100, such as a liquid crystal display or an Electro-Luminescence (EL) display, for example. For example, display 42 is a center display disposed in the center of the instrument panel of vehicle 100. Display 42 may be a touch-screen display. If vehicle 100 is equipped with a car navigation system, display 42 may be used as a display for the car navigation system. Display 42 may also be another display provided to vehicle 100, such as a meter display. Display 42 may also be a display brought into vehicle 100 from outside vehicle 100 by the user of vehicle 100, such as a portable display.

### (Examples of Display Control)

Examples of display control of emphasized image P1 and course image P2 that is performed by display control system 1 according to the embodiment will be described below with reference to FIGS. 2 and 3.

FIG. 2 is a diagram illustrating an example of an image displayed on display device 4 by display control system 1 according to the embodiment. FIG. 2 shows an example of an image displayed on display 42, which is one of the displays included in display device 4. In the example shown in FIG. 2, a bird's-eye view image of vehicle 100 as viewed from above, i.e., a surround view monitor image, is displayed on display 42.

The bird's-eye view image is generated by combining into one, for example, a forward image showing the area forward of vehicle 100, which has been captured by a camera (sensor 2) disposed at the front of vehicle 100, a rearward image showing the area rearward of vehicle 100, which has been captured by a camera (sensor 2) disposed at the rear of vehicle 100, a leftward image showing the area leftward of vehicle 100, which has been captured by a camera (sensor 2) disposed at a left part of vehicle 100, and a rightward image showing the area rightward of vehicle 100, which has been captured by a camera (sensor 2) disposed at a right part of vehicle 100.

As shown in FIG. 2, the bird's-eye view image displayed on display 42 shows: vehicle 100 viewed from above; shoulder A1 of the road viewed from above; and sidewalk A2 viewed from above. Note that the illustration of, for example, the detailed image of the road and images of buildings is omitted in the example shown in FIG. 2. Display controller 16 displays emphasized image P1 on display 42 so that emphasized image P1 is superimposed on the edge of obstacle A0 (in this case, curb A11 on shoulder A1 of the road). In the example shown in FIG. 2, display controller 16 displays linear emphasized images P1 on display 42 so that linear emphasized image P1 is superimposed on each of the edges of two curbs A11 extending in the front-back direction.

In the example shown in FIG. 2, no emphasized image P1 is displayed, in a superimposed manner, on a portion between these curbs A11, i.e., a gap between curbs A11. However, emphasized image P1 may be displayed, in a superimposed manner, on such a gap.

Display controller 16 also displays two curved course images P2 on display 42 so that course images P2 are superimposed on the area forward of vehicle 100. These two curved images represent a predicted trajectory of the front left wheel of vehicle 100 and a predicted trajectory of the front right wheel of vehicle 100.

The driver of vehicle 100 can drive while being aware of whether vehicle 100 will come into contact with curb A11 by viewing emphasized image P1 and course images P2 that are displayed on display 42. Thus, the anxiety the driver of vehicle 100 may have when driving (in this case, when pulling over) can be easily reduced. In the example shown in FIG. 2, in particular, since the driver can drive while viewing emphasized image P1 and course images P2 that are displayed in the bird's-eye view image, the driver can easily recognize the positions of vehicle 100 and curb A11.

FIG. 3 is a diagram illustrating another example of the image displayed on display device 4 by display control system 1 according to the embodiment. In the example shown in FIG. 3, emphasized image P1 and course images P2, which are projected from HUD 41, are displayed on windshield 101 of vehicle 100. Thus, the forward view of vehicle 100 through windshield 101 as well as emphasized image P1 and course images P2 are shown in the visual field of the driver of vehicle 100. Note that the illustration of, for example, the detailed image of the road and images of buildings is omitted in the example shown in FIG. 3.

As shown in FIG. 3, the road forward of vehicle 100 and shoulder A1 of the road are shown in the visual field of the driver of vehicle 100. Display controller 16 displays emphasized image P1 on display 42 so that emphasized image P1 is superimposed on the edge of obstacle A0 (in this case, curb A11 on shoulder A1 of the road). In the example shown in FIG. 3, display controller 16 projects linear emphasized image P1 onto windshield 101 so that emphasized image P1 is superimposed on the edge of curb A11 extending forward.

Display controller 16 also projects two linear course images P2 onto windshield 101 so that course images P2 are superimposed on the area forward of vehicle 100. These two linear images represent a predicted trajectory of the front left wheel of vehicle 100 and a predicted trajectory of the front right wheel of vehicle 100.

The driver of vehicle 100 can drive while being aware of whether vehicle 100 will come into contact with curb A11 by viewing emphasized image P1 and course images P2 that are projected onto windshield 101 of vehicle 100. Thus, the anxiety the driver of vehicle 100 may have when driving (in this case, when pulling over) can be easily reduced. In the example shown in FIG. 3, in particular, the driver can drive while viewing emphasized image P1 and course images P2 without shifting his/her point of view from windshield 101.

Note that display control system 1 may perform both or one of the control to display emphasized image P1 and course image P2, in a superimposed manner, on display 42 and the control to project emphasized image P1 and course image P2, in a superimposed manner, onto windshield 101.

### (Operations)

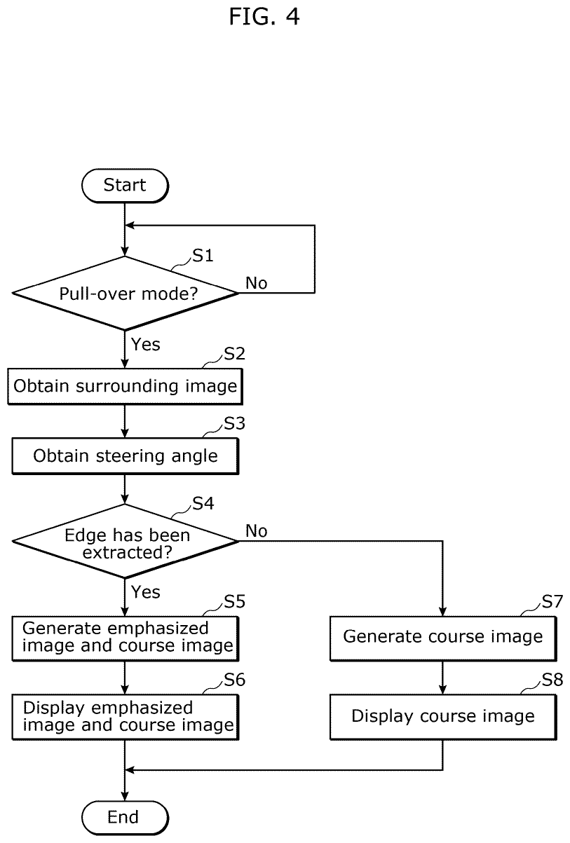

Operations of display control system 1 according to the embodiment will be described below with reference to FIG. 4. FIG. 4 is a flowchart showing an example of operations of display control system 1 according to the embodiment.

First, determiner 14 determines whether the driving mode of vehicle 100 has been shifted to the pull-over mode (S1). When the driving mode of vehicle 100 has not been shifted to the pull-over mode (S1: No), determiner 14 determines that neither emphasized image P1 nor course image P2 is to be displayed, in a superimposed manner, on display device 4. When the driving mode of vehicle 100 has been shifted to the pull-over mode (S1: Yes), on the other hand, determiner 14 determines that emphasized image P1 and course image P2 are to be displayed, in a superimposed manner, on display device 4. In this case, display control system 1 executes steps subsequent to step S1.

Next, first obtainer 11 obtains a surrounding image (S2). Second obtainer 12 also obtains a steering angle of vehicle 100 (S3). Note that steps S2 and S3 need not be performed in this order. For example, steps S2 and S3 may be performed in the order of step S3 and step S2, or may be performed simultaneously and in parallel. Alternatively, steps S2 and S3 may be executed constantly regardless of the result of step S1.

Next, extractor 13 performs the process of extracting an edge of obstacle A0 in the surrounding image obtained by first obtainer 11 (S4). When the edge of obstacle A0 has been extracted in the surrounding image (S4: Yes), display control system 1 performs steps S5 and S6. When the edge of obstacle A0 has not been extracted in the surrounding image (S4: No), display control system 1 performs steps S7 and S8.

When the edge of obstacle A0 has been extracted in the surrounding image, generator 15 generates emphasized image P1 that emphasizes the edge of obstacle A0 extracted by extractor 13, and course image P2 that represents a travel course of vehicle 100 predicted based on the steering angle obtained by second obtainer 12 (S5). Display controller 16 then displays emphasized image P1 and course image P2 that are generated by generator 15, in a superimposed manner, on display device 4 provided to vehicle 100 (S6).

When the edge of obstacle A0 has not been extracted in the surrounding image, on the other hand, generator 15 generates course image P2 representing a travel course of vehicle 100 predicted based on the steering angle obtained by second obtainer 12 (S7). Display controller 16 then displays course image P2 generated by generator 15, in a superimposed manner, on display device 4 provided to vehicle 100 (S8).

Thereafter, display control system 1 repeats the process from steps S2 to S8 while the driving mode of vehicle 100 is in the pull-over mode. Display control system 1 terminates the process from steps S2 to S8 when the driving mode of vehicle 100 is shifted to a mode other than the pull-over mode.

### Advantageous Effects

The advantageous effects of display control system 1 according to the embodiment will be described below. As described above, display control system 1 according to the embodiment extracts the edge of obstacle A0 in the surrounding image including at least the area forward of vehicle 100 and the area that is lateral to vehicle 100 and is on the side where obstacle A0 to vehicle 100 is present, and displays emphasized image P1 that emphasizes the edge and course image P2 that represents the predicted travel course of vehicle 100, in a superimposed manner, on display device 4. Thus, with display control system 1 according to the embodiment, the driver can drive while being aware of whether vehicle 100 will come into contact with obstacle A0 by viewing emphasized image P1 and course image P2 that are displayed on display device 4. Thus, an advantageous effect of display control system 1 according to the embodiment is that the anxiety the driver may have when driving can be easily reduced.

Display control system 1 according to the embodiment is effective especially when the driver pulls over. The pull-over operation as used herein refers to a non-intuitive driving operation to pull vehicle 100 over to shoulder A1 of the road. This is a driving operation that relatively many drivers are not good at. Thus, an advantageous effect of display control system 1 according to the embodiment is that the driver, when pulling over, can drive while viewing the edge of curb A11 on shoulder A1 of the road and the predicted travel course of vehicle 100, and the anxiety the driver may have when pulling over can be thereby easily reduced.

As already mentioned, with the technique disclosed in PTL 1, the driver drives while worrying about when the warning sound or voice announcement will be made during the pull-over operation, and thus the driver drives with anxiety after all. Display control system 1 according to the embodiment, in contrast, can solve such an issue because the driver can drive while viewing the edge of curb A11 on shoulder A1 of the road and the predicted travel course of vehicle 100.

Furthermore, with the technique disclosed in PTL 1, no warning sound or voice announcement being made when vehicle 100 was pulled over means that vehicle 100 may not have been pulled over sufficiently to curb A11. For example, the driving operation may be ended without vehicle 100 entering an area within a predetermined distance from the edge of curb A11. In this case, no warning sound is emitted, but it cannot be said that vehicle 100 has been pulled over sufficiently to the edge of curb A11. With display control system 1 according to the embodiment, in contrast, such an issue can be solved because the driver can drive while viewing the edge of curb A11 on shoulder A1 of the road and the predicted travel course of vehicle 100.

### (Variations)

The display control system according to the present disclosure has been described above based on the above embodiment, but the present disclosure is not limited to the embodiment. Forms obtained by making various modifications to the above embodiment that can be conceived by those skilled in the art without materially departing from the spirit of the present disclosure may be included in the scope of the present disclosure.

In the above embodiment, generator 15 may generate course images P2 representing a travel course predicted further based on an inner wheel difference and an outer wheel difference of vehicle 100. For example, generator 15 may predict trajectories of the two front wheels of vehicle 100 based on the steering angle obtained by second obtainer 12, further correct the trajectories in consideration of the inner wheel difference and the outer wheel difference, and generate course images P2 representing the corrected trajectories.

In the above-described embodiment, determiner 14 determines whether emphasized image P1 and course image P2 are to be displayed, in a superimposed manner, on display device 4 based on whether the driving mode of vehicle 100 has been shifted to the pull-over mode. However, the present disclosure is not limited to this. For example, determiner 14 may determine that emphasized image P1 and course image P2 are to be displayed, in a superimposed manner, on display device 4 when a distance (e.g., shortest distance) between a travel line representing the predicted travel course of vehicle 100 and the edge of obstacle A0 extracted by extractor 13 is below a threshold value. In other words, display controller 16 may display emphasized image P1 and course image P2, in a superimposed manner, on display device 4 when the distance between the travel line and the edge is below the threshold value. The travel line as used herein refers to one of the two trajectories of the two front wheels of vehicle 100 that is closer to obstacle A0.

In the above-described embodiment, display controller 16 may change the display style of emphasized image P1 and course image P2 according to the distance between the travel line and the edge. For example, display controller 16 may change the color of emphasized image P1 and course image P2 to be closer to red as the distance becomes shorter. For example, display controller 16 may also change the thicknesses of the lines shown by emphasized image P1 and course image P2 to be larger as the distance becomes shorter. For example, display controller 16 may also cause emphasized image P1 and course image P2 to blink when the distance is below the threshold value.

In the above-described embodiment, when a gap is present between a plurality of obstacles A0, display controller 16 may display the gap on display device 4 in a superimposed manner with a style different from that of emphasized image P1. For example, display controller 16 may set the color of an image to be displayed, in a superimposed manner, on the gap to a color different from the color of emphasized image P1.

In the above-described embodiment, display controller 16 may constantly display emphasized image P1 and course image P2, in a superimposed manner, on the image displayed by display device 4 regardless of the determination result of determiner 14. In this case, display control system 1 may include no determiner 14.

In the above-described embodiment, display device 4 may include only one of HUD 41 or display 42. When display device 4 includes only HUD 41, display control system 1 only needs to perform the control to project emphasized image P1 and course image P2, in a superimposed manner, onto windshield 101 as in the example shown in FIG. 3. When display device 4 includes only display 42, on the other hand, display control system 1 only needs to perform the control to display emphasized image P1 and course image P2, in a superimposed manner, on display 42 as in the example shown in FIG. 2.

Display control system 1 is implemented by an in-vehicle device in the above-described embodiment, but is not limited to this. For example, display control system 1 may be included in a server device different from vehicle 100 and may be configured to display an image on display device 4 through wireless communication between the server device and vehicle 100. Display control system 1 may have a composite configuration in which part of display control system 1 is included in vehicle 100 and the remaining part of display control system 1 is included in the server device.

Each of the components included in display control system 1 according to the above-described embodiment is realized as a Large-Scale Integration (LSI) chip, which is typically an integrated circuit. These components may be individually configured as a single chip, or may be integrated into a single chip to include some or all of the components.

The circuit integration technique is not limited to LSI, and circuit integration may be realized using a dedicated circuit or a general-purpose processor. A Field Programmable Gate Array (FPGA), which can be programmed after the manufacturing of the LSI chip, or a reconfigurable processor, which can reconfigure the connections and settings of circuit cells inside the LSI chip, may also be used.

In the above-described embodiment, each component may be configured as dedicated hardware or may be implemented by executing a software program suitable for the component. Each component may be implemented by a program executer, such as a Central Processing Unit (CPU) or a processor, reading and executing a software program recorded on a recording medium, such as a hard disk or a semiconductor memory.

All numerical values used above are given by way of example only to specifically describe the present disclosure, and therefore the embodiment of the present disclosure is not limited by the exemplary numerical values.

The division of the functional blocks in the block diagram is presented by way of example. A plurality of functional blocks may be implemented as a single functional block, a single functional block may be divided into a plurality of functional blocks, or some functions may be transferred to other functional blocks. The functions of a plurality of functional blocks with similar functions may be processed by a single piece of hardware or software in parallel or time-division.

The order in which the steps in the flowchart are executed is presented by way of example for the purpose of specifically describing the present disclosure, and therefore those steps may be executed in any order other than the order described above. Some of the above-described steps may be executed simultaneously (in parallel) with other steps.

Forms obtained by making various modifications to the above-described embodiment that can be conceived by those skilled in the art, as well as forms obtained by combining structural components and functions in the embodiment, without materially departing from the spirit of the present disclosure, may be included in the scope of the present disclosure.

### SUMMARY

As described above, display control system 1 according to a first aspect includes first obtainer 11, second obtainer 12, extractor 13, generator 15, and display controller 16. First obtainer 11 obtains a surrounding image including at least an area forward of vehicle 100 and an area that is lateral to vehicle 100 and is on a side where obstacle A0 to vehicle 100 is present. Second obtainer 12 obtains a steering angle of vehicle 100. Extractor 13 extracts an edge of obstacle A0 in the surrounding image. Generator 15 generates emphasized image P1 that emphasizes the edge extracted, and course image P2 that represents a travel course of vehicle 100 predicted based on the steering angle. Display controller 16 displays emphasized image P1 generated and course image P2 generated, in a superimposed manner, on display device 4 provided to vehicle 100.

According to this, the driver can drive while being aware of whether vehicle 100 will come into contact with obstacle A0 by viewing emphasized image P1 and course image P2 that are displayed on display device 4. Thus, this can provide an advantage of easily reducing the anxiety the driver may have when driving.

Furthermore, in display control system 1 according to a second aspect, for example, generator 15, in the first aspect, generates course image P2 that represents the travel course predicted further based on an inner wheel difference of vehicle 100 and an outer wheel difference of vehicle 100.

According to this, the travel course of vehicle 100 is predicted in consideration of the inner wheel difference and the outer wheel difference of vehicle 100. Thus, this can provide an advantage of easily improving the accuracy of the predicted travel course of vehicle 100 represented by course image P2 superimposed on display device 4.

Furthermore, in display control system 1 according to a third aspect, for example, display device 4 is display 42 in the first or second aspect. Display controller 16 displays emphasized image P1 and course image P2, in a superimposed manner, on a bird's-eye view image displayed on display 42, the bird's-eye view image showing vehicle 100 viewed from above.

According to this, the driver can drive while viewing emphasized image P1 and course image P2 that are displayed on the bird's-eye view image. Thus, this can provide an advantage of allowing the driver to easily recognize the positions of vehicle 100 and obstacle A0, and thus easily reducing the anxiety the driver may have when driving.

Furthermore, in display control system 1 according to a fourth aspect, for example, display device 4 is head-up display 41 in any one of the first to third aspects. Display controller 16 displays emphasized image P1 and course image P2, in a superimposed manner, on windshield 101 of vehicle 100.

According to this, the driver can drive while viewing emphasized image P1 and course image P2 without shifting his/her point of view from windshield 101. Thus, this can provide an advantage of easily reducing the anxiety the driver may have when driving.

Furthermore, in display control system 1 according to a fifth aspect, for example, when vehicle 100 is shifted to a mode to perform a pull-over operation of pulling vehicle 100 over to obstacle A0 in any one of the first to fourth aspects, display controller 16 displays emphasized image P1 and course image P2, in a superimposed manner, on display device 4.

According to this, emphasized image P1 and course image P2 are displayed on display device 4 when the driver pulls over. Thus, this can provide an advantage of allowing the driver to pull over more easily, and thus easily reducing the anxiety the driver may have when driving. Furthermore, according to this, emphasized image P1 and course image P2 are displayed on display device 4 only when the driver pulls over. Thus, this can provide an advantage of allowing the driver to concentrate more on driving at times other than when pulling over, compared to a case where emphasized image P1 and course image P2 are constantly displayed.

Furthermore, in display control system 1 according to a sixth aspect, for example, when a distance between the edge and a travel line representing the travel course is below a threshold value in any one of the first to fourth aspects, display controller 16 displays emphasized image P1 and course image P2, in a superimposed manner, on display device 4.

According to this, emphasized image P1 and course image P2 are not displayed on display device 4 until vehicle 100 becomes more likely to come into contact with obstacle A0. Thus, this can provide an advantage of easily preventing the driver from becoming overly cautious about driving.

Furthermore, in display control system 1 according to a seventh aspect, for example, display controller 16 changes a display style of at least one of emphasized image P1 or course image P2 according to a distance between the edge and a travel line representing the travel course in any one of the first to sixth aspects.

According to this, the display style of at least one of emphasized image P1 or course image P2 is changed according to a degree of proximity of vehicle 100 to obstacle A0. Thus, this can provide an advantage of allowing the driver to easily recognize the degree of proximity of vehicle 100 to obstacle A0, and thus easily reducing the anxiety the driver may have when driving.

Furthermore, in a display control method according to an eighth aspect, for example, a surrounding image including at least an area forward of vehicle 100 and an area that is lateral to vehicle 100 and is on a side where obstacle A0 to vehicle 100 is present is obtained (S2). In the display control method, a steering angle of vehicle 100 is obtained (S3). In the display control method, an edge of obstacle A0 in the surrounding image is extracted (S4). In the display control method, emphasized image P1 that emphasizes the edge extracted, and course image P2 that represents a travel course of vehicle 100 predicted based on the steering angle are generated (S5). In the display control method, emphasized image P1 generated and course image P2 generated are displayed, in a superimposed manner, on display device 4 provided to vehicle 100 (S6).

According to this, the driver can drive while being aware of whether vehicle 100 will come into contact with obstacle A0 by viewing emphasized image P1 and course image P2 that are displayed on display device 4. Thus, this can provide an advantage of easily reducing the anxiety the driver may have when driving.

While the embodiment has been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in their entirety: Japanese Patent Application No. 2024-101448 filed on Jun. 24, 2024.

### INDUSTRIAL APPLICABILITY

In a mobile object such as a vehicle, for example, the present disclosure is applicable to a system for supporting a driver to drive the vehicle.

1. A display control system comprising:
a memory; and
a processor connected to the memory,
wherein, using the memory, the processor:
obtains a surrounding image including at least an area forward of a vehicle and an area that is lateral to the vehicle and is on a side where an obstacle to the vehicle is present;
obtains a steering angle of the vehicle;
extracts an edge of the obstacle in the surrounding image;
generates an emphasized image that emphasizes the edge extracted, and a course image that represents a travel course of the vehicle predicted based on the steering angle; and
displays the emphasized image generated and the course image generated, in a superimposed manner, on a display device provided to the vehicle.

2. The display control system according to claim 1,
wherein the processor generates the course image that represents the travel course predicted further based on an inner wheel difference of the vehicle and an outer wheel difference of the vehicle.

3. The display control system according to claim 1,
wherein the display device is a display, and
the processor displays the emphasized image and the course image, in a superimposed manner, on a bird's-eye view image displayed on the display, the bird's-eye view image showing the vehicle viewed from above.

4. The display control system according to claim 1,
wherein the display device is a head-up display, and
the processor displays the emphasized image and the course image, in a superimposed manner, on a windshield of the vehicle.

5. The display control system according to claim 1,
wherein when the vehicle is shifted to a mode to perform a pull-over operation of pulling the vehicle over to the obstacle, the processor displays the emphasized image and the course image, in a superimposed manner, on the display device.

6. The display control system according to claim 1,
wherein when a distance between the edge and a travel line representing the travel course is below a threshold value, the processor displays the emphasized image and the course image, in a superimposed manner, on the display device.

7. The display control system according to claim 1,
wherein the processor changes a display style of at least one of the emphasized image or the course image according to a distance between the edge and a travel line representing the travel course.

8. A display control method comprising:
obtaining a surrounding image including at least an area forward of a vehicle and an area that is lateral to the vehicle and is on a side where an obstacle to the vehicle is present;
obtaining a steering angle of the vehicle;
extracting an edge of the obstacle in the surrounding image;
generating an emphasized image that emphasizes the edge extracted, and a course image that represents a travel course of the vehicle predicted based on the steering angle; and
displaying the emphasized image generated and the course image generated, in a superimposed manner, on a display device provided to the vehicle.
